(19) United States
(12) Patent Application Publication
(10) Pub. No.: US 2010/0320736 A1
(43) Pub. Date: Dec. 23, 2010

(54) Airbag

(75) Inventors: Bruno Traber, Munsingen (CH); Benjamin Grimminger, Bern (CH); Hans-Joachim Studt, Hardegsen/Lichtenborn (DE); Olaf Meincke, Bern (CH); Adrian Schulthess, Tentlingen (CH)

Correspondence Address: SHOEMAKER AND MATTARE, LTD, 10 POST OFFICE ROAD - SUITE 100, SILVER SPRING, MD, 20910, US

(73) Assignee: NOLAX AG, Sempach Station (CH)

(21) Appl. No.: 12/528,154

(22) PCT Filed: Feb. 28, 2008
(86) PCT No.: PCT/EP08/52406

§ 371 Date: Aug. 21, 2009

(30) Foreign Application Priority Data
Mar. 8, 2007 (EP) 07103806.1

(51) Int. Cl. B60R 21/235; B32B 9/04; C09J 5/06; B32B 7/08

(52) U.S. Cl. 280/743.1; 428/411.1; 156/321; 156/91

(57) ABSTRACT

The invention relates to an airbag with wall parts (1, 2), which comprise or consist of a laminated material, the laminated material comprising: (a) a backing layer (3), in particular comprising a gas-permeable textile sheet-like structure, preferably a layer of woven or knitted fabric, and (b) an at least two-layered, in particular co-extruded polymer film (4), a first polymer layer (5), facing towards the backing layer, having a glass transition temperature Tg1 of less or equal than 10° C., with preference less or equal than 0° C., with particular preference less or equal than −20° C., and a second polymer layer (6), facing away from the backing layer, having a storage modulus according to the torsion pendulum test as specified by DIN 53 445 of more or equal than 1 MPa at more or equal than 90° C., with preference more or equal than 110° C. and with particular preference more or equal than 120° C. The wall parts are joined together here in at least one joining region, in particular only in edge regions of the airbag, in such a way that the second polymer layers of the wail parts are either joined to one another directly or joined to one another indirectly by way of an intermediate portion (7).

The invention relates to an airbag, a method for producing such an airbag and also to a polymer film and a laminated material according to the independent patent claims.

Airbags are currently used in particular in automobiles. In the event of a collision, the airbags are inflated in fractions of a second and are intended to prevent impact of the passengers with parts of the vehicle, such as for example the steering wheel, dashboard or side parts of the vehicle. To be able to ensure that the airbag remains intact for an adequate time in the event of a collision, it must be adequately sealed. There are various ways of ensuring the integrity of the seal:

Known in the prior art are one-piece woven airbags (OPWs), which can be produced in one piece, that is to say without any seams, in an elaborate weaving process. However, OPWs are not generally adequately sealed, so that further sealing is necessary. Such further sealing is achieved by laminating on thin films, which are intended to ensure the integrity of the seal of the airbag; such a method is described, for example, in DE 102 24 771 A1. However, this makes the in any case very cost-intensive production of the OPWs even more expensive. Moreover, application of the film to the outer side of the OPW is disadvantageous, since the lamination of the film lying on the outside can be impaired by the gas passing through the fabric of the OPW, which in the most unfavourable case could lead to inflation of the film and, at worst, to tearing of the film enclosure.

Likewise known are sewn airbags. In the case of such airbags, additional sealing in the regions of the seams is absolutely necessary. This may take place for example by silicone coatings; however, in the folded state of the airbag, such coatings have a tendency to stick to the opposite side. The reliable film coating of an airbag with finished seams is made more difficult in the region of the seams, however, as a result of elevations caused in places by the seam: in the region of the seam, fracturing of the lamination in the inflated state of the airbag may pose a risk. Coating of the airbag fabric with the film before sewing does not solve this problem: the film would be perforated during the sewing, leading to a break in the seal.

It is therefore an object of the invention to avoid the disadvantages of the known art, in particular to provide an airbag which can be produced at low cost and can be sealed easily and reliably.

This object is achieved by the subjects of the independent patent claims.

An airbag according to the invention comprises at least one wall part, in particular two wall parts. The airbag can be produced from a single wall part if it is suitably cut to size; this wall part can then be folded over over one edge region and be joined in the remaining edge regions. It goes without saying, however, that production from two (or more) originally separate wall parts is also possible. The wall part or parts comprise(s) or consist(s) of a laminated material, the laminated material comprising:
a backing layer, in particular comprising a gas-permeable textile sheet-like structure, preferably a layer of woven or knitted fabric,
an at least two-layered, in particular co-extruded polymer film, a first polymer layer, facing towards the backing layer, having a glass transition temperature T_{g1} of ≦10° C., with preference ≦0° C., with particular preference ≦−20° C., and a second polymer layer, facing away from the backing layer, having a storage modulus according to the torsion pendulum test as specified by DIN 53 445 of ≧1 MPa at ≧90° C., with preference ≧110° C. and with particular preference ≧120° C. The glass transition temperature T_{g2} of the second polymer layer is in this case preferably >T.

The “T_{g} of a polymer layer” is understood here and hereafter as meaning in each case the T_{g} that substantially determines the behaviour of the layer.

The torsion pendulum test as specified by DIN 53 445 is carried out with the following measures. Test piece geometry: flat bar, width 10 mm, length 50 mm, thickness 1 mm. The test piece is produced by a heated punch press and a suitable mould. For conditioning, the test piece is stored at 40° C. in a vacuum drying cabinet for 24 hours. Initial temperature: 23° C.; heating rate of 2° C./min.

The wall part or parts are joined together in at least one joining region, in particular only in edge regions of the airbag. The joining together is in this case carried out in such a way that the second polymer layers of the wall part or parts are either joined to one another directly or joined to one another indirectly by way of an intermediate portion. The first polymer layer typically serves for laminating the polymer film onto the backing layer. With suitable configuration of a polymer layer and in particular suitable application thickness, it is also possible for just a single polymer layer with the properties of both the first polymer layer and the second polymer layer to be provided in the case of one wall part, in particular in the case of both wall parts, provided that the aforementioned requirements for the integrity of the seal (time it remains intact) and the strength of the adhesive bond are met.

It has surprisingly been found that, by specifically designed configuration of the polymer film, this film can be used both for the sealing of the airbag and for the joining of the partial regions; it is possible to dispense completely with additional mechanical joining means, such as for example seams. This multifunctionality of the film obviously both simplifies the production of the airbag and makes the sealing more reliable: films no longer have to be laminated over existing seams, which can lead to breaks of the seal, but instead the film itself is used as a joining means, for example by specific melting and re-cooling of the polymer layers lying one on top of the other. It goes without saying that not only the use of purely physically melting and re-solidifying polymer layers is possible, but for example the use of reactive polymer layers, which for example undergo chemical post-crosslinking when a certain amount of energy is introduced. This post-crosslinking may take place, for example, by UV radiation, electron radiation or thermally. Preferably, latently reactive systems may also be used. Such polymer systems are known per se to a person skilled in the art (for example from EP 1 469 036 B1) and can be used within the scope of the invention, provided that processing in the form of films is possible. With regard to chemically post-crosslinking polymer systems, reference is made to Radiation Curing in Polymer Science and Technology Vol 1-4, Ed. J. P. Fouassier & J. F. Rabek, Elsevier Applied Science, 1993; the disclosure of this publication in relation to post-crosslinkable systems is incorporated in the present description by reference.

In particularly preferred embodiments of the airbag, the wall part or parts of the airbag are arranged in such a way that the textile sheet-like formation of the laminated material is on the outside in the operating state of the airbag. This allows the risk described above of the lamination comprising the film and backing layer tearing open being prevented when the film is arranged on the outside; when the film is arranged on the inside, if anything the film is pressed against the fabric by the gas entering, but delamination is not possible.

It is particularly advantageous if the glass transition temperature T_{g1} is ≦−30° C. and the glass transition temperature T_{g2} of the second polymer layer is ≦20° C. (preferably ≦0° C.).

The material of the first polymer layer, which also represents the adhesive layer of the polymer film with respect to the backing layer, is intended to have a glass transition temperature T_{g1} that is as low as possible, since the layer must be as soft and flexible as possible; in particular, it must still be adequately flexible at −30° C. This flexibility ensures that the adhesive layer can ensure adequate bonding of the polymer film to the fabric even at low temperatures. The first polymer layer has a lower melting range than the material of the second layer, which serves a) as the outer layer of the polymer film and b) as the adhesive layer of the polymer film with respect to the other (part of the) wall part. This material must meet a series of requirements: the material must have a high melting temperature; uncontrolled bonding of the second polymer layer to another, second polymer layer lying on it must be ruled out to the greatest extent, even during storage at a temperature above 90° C., preferably even at a temperature above 120° C. Then, adequate flexibility of the material of the second polymer layer is also necessary at a temperature of −30° C. (The temperature of −30° C. represents a standard temperature for testing the stability of an airbag material at low temperatures). At such a low temperature, the second polymer layer must remain intact to allow the integrity of the seal of the polymer film to be maintained during the unfolding of the airbag.

With preference, the first polymer layer consists of low-melting, soft polymers with a T_{g1} of, with special preference, <−20° C. and is able to enter into a good bond with a material used for the backing layer. With preference, materials may also be polyurethanes with a melting range of 90 to 160° C. and a Shore A hardness lower than 95 (corresponding products are produced, for example, by the companies Huntsman, Huntsman Polyurethanes, 2190 Executive Hills Boulevard, Auburn Hills, Mich. 48326, USA; Bayer Materialscience, DE-51368 Leverkusen, Germany or Merquinsa, Gran Vial 17, 08160 Montmelo, Barcelona, Spain). The following may be used as further materials: polyethylene, copolymers of ethylene and higher 1-olefins (LLDPE, VLDPE, etc.) and with preference also polyolefin-based functional copolymers. Corresponding products are produced by the companies Exxon, Basell, Total Petrochemicals, DOW or Arkema. The materials described above may be used (on their own or in combination or mixture with other polymers).

The aforementioned uncontrolled bonding of the second polymer layer must not occur when the airbag is in the folded-together, installed state. With preference, the material of the second polymer layer comprises a co-polyester, a co-polyamide or a polyamide elastomer. The material has in this case a storage modulus according to the torsion pendulum test as specified by DIN 53 445 of ≧1 MPa at ≧90° C., with preference ≧110° C. and with particular preference ≧120° C. Such materials can meet the set requirements, i.e. they have a low sliding friction value, good low-temperature impact strength, good scrub resistant, are very flexible and soft. Further preferred are polymeric materials from the group of thermoplastic elastomers, since they have high flexibility, softness and low-temperature impact strength. Specifically, polyamide elastomers have a favourable range of properties; they are sold, inter alia, by the Degussa company (Vestamid E series) or the Arkema company (PEBAX series). The materials described above may be used (on their own or in combination or mixture with other polymers).

Additional layers in the laminated structure are also conceivable. Additional layers may be routinely chosen by a person skilled in the art in laminates according to the invention to correspond to specific tasks, such as for example ensuring adequate interlayer bonding, improving mechanical properties, such as for example the impact strength or puncture resistance, or else the thermal stability in the case of high-melting (T_{e3 of the additional layer}>Tₑ₂) layers. Particularly advantageously, an additional, high-melting layer, for example with a melting point of >180° C., may be inserted between the first polymer layer and the second polymer layer. The high melting point of such an intermediate layer can effectively prevent the polymer laminate from penetrating into the backing material deeper than desired, and so potentially impairing the adhesive bond in the backing material, in particular a woven fabric, during the thermal melting (or softening) of the second polymer layer, in which the first polymer layer also (re)softens on account of its lower softening temperature. This can be effectively avoided by the high-melting intermediate layer.

The co-polyester, the co-polyamide or the polyamide elastomer may, if appropriate, contain additives such as antioxidants, lubricants (for example fatty acid amides) or anti-blocking agents (for example silica), which improve the properties of these materials, such as for example stability or processability.

In a further, advantageous embodiment of the laminated material, the material of the first and/or the second polymer layer contains at least one flame retardant. These flame retardants may be based on halogen-containing or halogen-free components. The halogen-containing flame retardant compositions contain, for example, decabromocyclohexane, decabromodiphenylene etc. and/or antimony(III) oxide (Sb₂O₃) in a carrier polymer, which is usually LDPE. Halogen-free flame retardants may also be used, for example phosphate esters, aluminium oxide trihydrate, magnesium oxide dihydrate, red phosphorus, zinc borate, ammonium polyphosphates, melamine cyanurate, zinc stannate or zinc hydroxide stannate. The addition of a flame retardant increases the stability of the polymer film of the airbag laminated material with respect to thermal loading by the hot combustion gases that are released when the airbag is triggered. This avoids the polymer film melting through or bursting into flames, and consequently malfunctioning of the airbag.

It is also conceivable for at least one of the layers of the polymer film to be coloured.

The laminated material, in particular for an airbag, advantageously has a backing layer, which may be produced, for example woven, from polyamide or polyester filaments or yarn. The backing layer may also be similar to a nonwoven or be knitted or formed as a mesh (gauze). The backing material and the polymer film must be joined. This can be achieved in particular by adhesive bonding or preferably a laminating operation. In this case it is possible, for example, for the first polymer layer or the backing material to be heated to a temperature above the softening temperature of the first polymer layer and then the backing layer and the polymer film to be joined by pressing or on a laminating installation. The backing layer may also be pretreated or precoated.

In particularly preferred embodiments of the airbag, the at least two-layered polymer film is laminated onto the backing layer, in particular by means of the first polymer layer and by a first introduction of energy E₁; and/or the joining of the second polymer layers of various wall parts is brought about by a second introduction of energy E₂. Particularly preferably, the backing layers and polymer layers are of such a nature that the first polymer layer(s), but not essentially the second polymer layer(s), can be melted by the introduction of energy E₁, and that the second polymer layer(s), but not essentially the first polymer layer(s), can be melted by the introduction of energy E₂. Such an orthogonal sensitivity of the polymer layers to the different introductions of energy E₁ and E₂ allows the two polymer layers to be selectively triggered in the production of the laminated material and of the airbag. This makes it possible in particular to avoid the disadvantage of simple thermal meltability of the two polymer layers: during the melting of the polymer layer that is flowable at a higher temperature (for example the second polymer layer), the polymer layer that (re)melts at the lower temperature (for example the first polymer layer) always melts, which is undesired, since this could, for example, impair the lamination of the backing layer with the first polymer layer. Typically, the first polymer layer, facing towards the backing layer, has a melting temperature Tₛ₁ and the second polymer layer, facing away from the backing layer, has a melting temperature Tₛ₂≠Tₛ₁, where in particular Tₛ₂>Tₛ₁. The orthogonal sensitivity can be set and increased by expert choice of additives, such as for example IR absorbers (for example carbon black) or HF-active substances (for example aluminium powder). The following publications, the disclosures of which in this respect are incorporated in the present description by reference, describe the high-frequency welding that can be used as a possible way of introducing energy within the scope of the present invention: Saechtling Kunststoff-Taschenbuch, 29th edition, Hanser Verlag 2004, pages 339-340: high-frequency welding (polymers with a loss factor tan d>0.1 can be welded with high frequency, for example: PVC, PUR, PVDC, EVA, PET, ABS); Schwarz, Ebeling, Furth: Kunststoff-Verarbeitung, Vogel Buchverlag 1999, pages 213-215 (the higher the dielectric loss factor tan d, the more polar the polymer and the better it can be heated in the capacitor field and under pressure).

In further advantageous embodiments, the second polymer layers of the wall parts may be joined to one another indirectly by way of an intermediate portion. In this case, the intermediate portion has on its sides facing towards the second polymer layers at least partially a material which is identical to or chemically compatible with the material of the second polymer layer(s). “Chemically compatible” is understood here as meaning that the material can be melted by introducing energy and as a result can enter into a bond (adhesive bond) with the second polymer layer that has essentially the same strength as the second polymer layer(s) with one another. In other words, the additional incorporation of an intermediate portion must not lead to a weakening of the laminate bond. In particular, the intermediate portion may comprise an inner portion, which may consist of a material that is also suitable as a backing layer of the wall part (see above); it is particularly preferred for the same material to be used for the backing layer and the intermediate portion. An immediate portion makes it possible, if appropriate, for additional stability to be imparted to the joining region or, given appropriate choice of material and if desired, additional elasticity.

It goes without saying that the wall part(s) may be additionally joined in joining regions by mechanical means, in particular by seams. With additional seams, it must be ensured that the integrity of the seal of the joining region is not impaired as a result; this is ensured particularly easily by the joining region in which the second polymer layers are joined to one another being dimensioned adequately in its width, so that additional sewing can be readily provided within the joining region.

A further aspect of the invention therefore relates to a method for producing an airbag described above. The method comprises the steps of:
a1) producing a laminated material comprising:
   a backing layer, in particular comprising a textile sheet-like structure, in particular a gas-permeable textile sheet-like structure, preferably a layer of woven or knitted fabric,
   an at least two-layered, in particular co-extruded polymer film, a first polymer layer, facing towards the backing layer, having a glass transition temperature T_{g1} of ≦10° C., with preference ≦0° C., with particular preference ≦−20° C., and a second polymer layer, facing away from the backing layer, having a storage modulus according to the torsion pendulum test as specified by DIN 53 445 of 1 MPa at ≧90° C., with preference ≧110° C. and with particular preference ≦120° C.;
   by directly coating the backing layer, in particular by extrusion of the polymer film onto the backing layer; or by subsequently bringing the backing layer and the polymer film into contact and introducing energy, in particular thermal energy, E₁;
      or
a2) providing such a laminated material.

The laminated material may be joined together here either in synchrony with production (“just-in-time”) by the airbag manufacturer from the polymer film and the backing layer or else already by the manufacturer of the polymer film. In any case, it is easily possible by choice of a backing layer and/or a polymer film that are appropriate for the respective use of the airbag to provide laminated materials that remain intact for various times (duration of adequate integrity of the seal in the inflated state).

The method further comprises the step of
b) joining together the laminated material, if appropriate after it has been made up into a suitably dimensioned wall parts, in joining regions, preferably only in edge regions, by introducing energy, in particular non-thermal energy, E₂ in such a way that the second polymer layers of the laminated materials are either joined to one another directly or joined to one another indirectly by way of an intermediate portion.

For the purpose of the introduction of energy, in particular thermal energy, E₁ and the introduction of energy, in particular non-thermal energy, E₂, the following come into consideration in particular: ultrasonic, infrared or high-frequency radiation, preferably high-frequency radiation.

As already described above, in particularly preferred embodiments, an at least two-layered polymer film or a laminated material with such a polymer film is provided, in the case of which the first polymer layer(s), but not essentially the second polymer layer(s), can be melted by the introduction of energy, in particular thermal energy, E₁, and in the case of which the second polymer layer(s) can be melted by the introduction of energy E₂.

A further aspect of the invention consequently relates to a laminated material for producing an airbag. The laminated material comprises a polymer film as described above, which polymer film is laminated with one of its polymer layers, in particular with its first polymer layer, onto a backing layer, preferably of a gas-permeable textile sheet-like formation.

A further aspect of the invention relates to a passive restraint system, in particular for a motor vehicle, comprising at least one airbag as described above.

The invention is explained in more detail below for better understanding on the basis of exemplary embodiments and figures, without restricting the subject matter of the invention to the embodiments that are shown. In the figures:

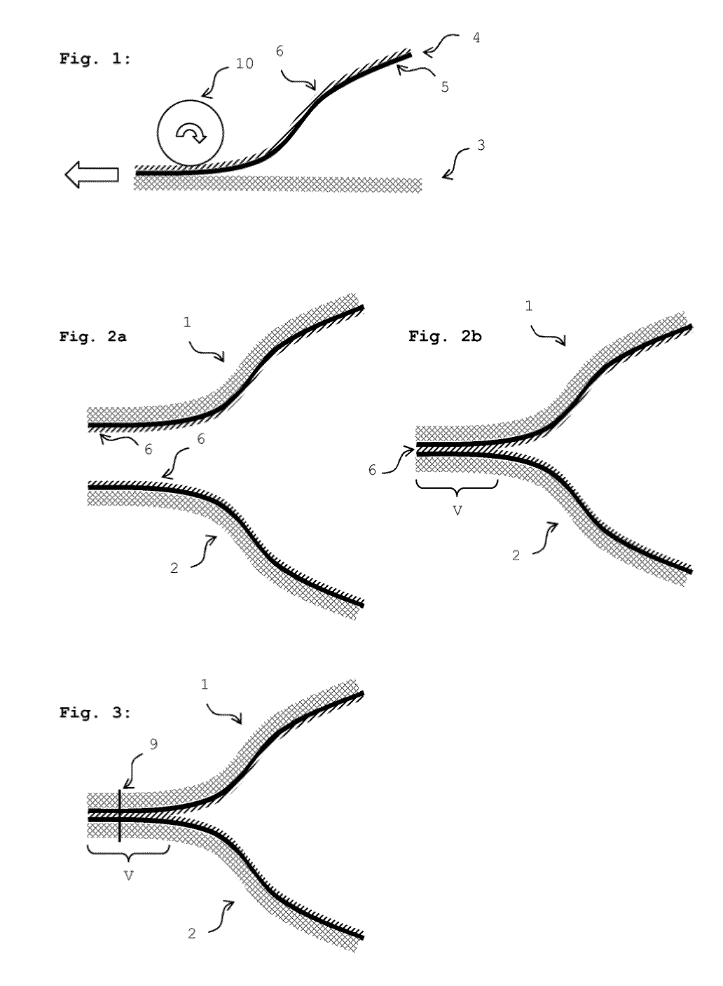

FIG. 1 shows the production of a laminated material;

FIG. 2 shows

a) wall parts of an airbag, separately;

b) wall parts of an airbag, joined;

FIG. 3 shows joined wall parts with an additional seam;

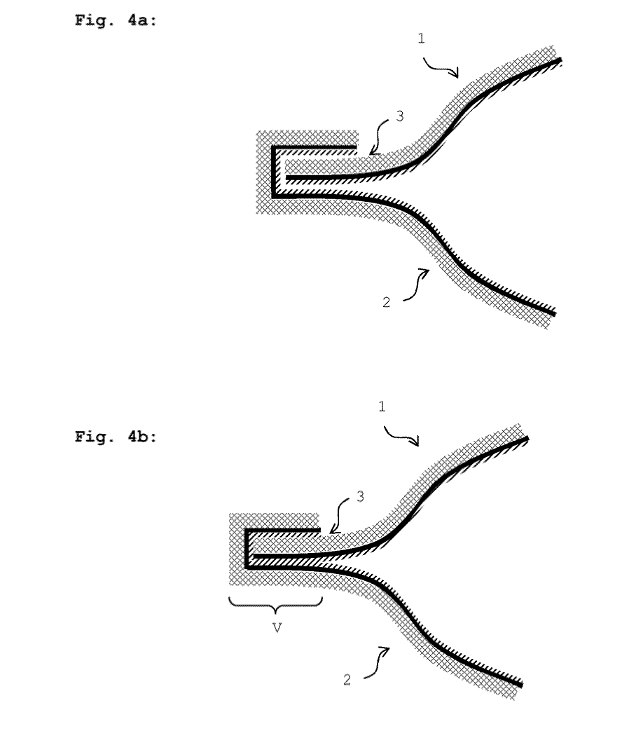

FIG. 4 shows

a) wall parts of an airbag, separately;

b) wall parts of an airbag, joined;

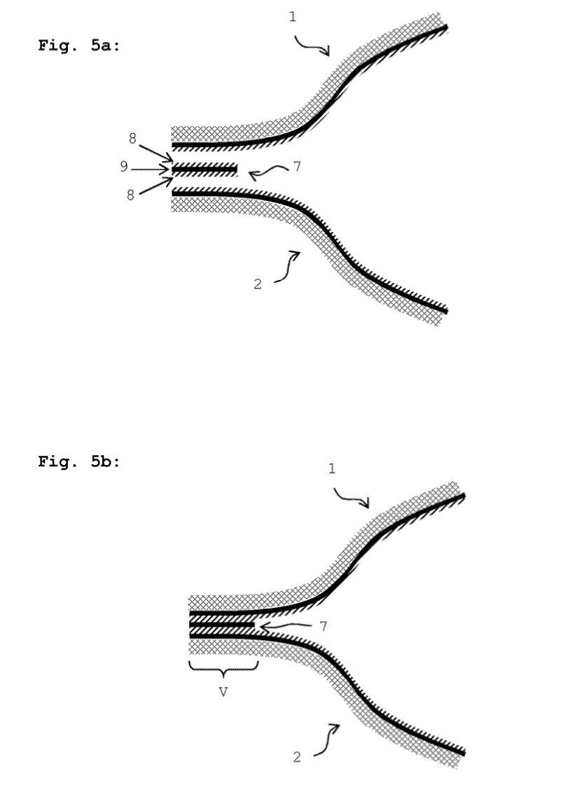

FIG. 5 shows

a) wall parts of an airbag with a flat intermediate portion, separately;

b) wall parts of an airbag with a flat intermediate portion, joined;

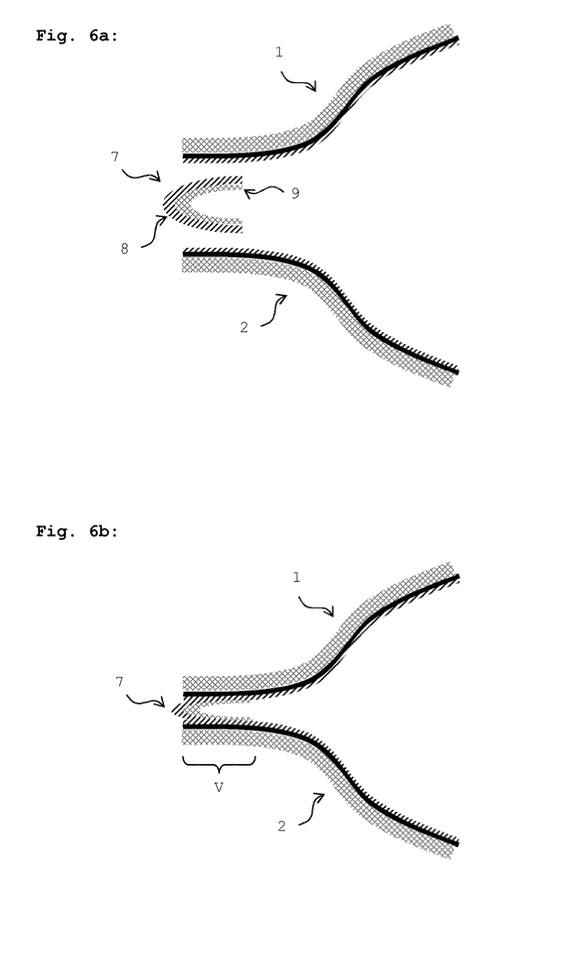

FIG. 6 shows

a) wall parts of an airbag with an intermediate portion to be introduced in an arcuate manner, separately;

b) wall parts of an airbag with an intimate portion introduced to an arcuate manner.

FIG. 1 schematically shows the production of a laminated material. For this purpose, a polymer film 4 is laminated with a first polymer layer 5 onto a backing layer 3. With preference, the laminating step is performed under the effect of a first introduction of energy E₁, in particular thermal energy, and a pressure applied by a pressing roller 10. This makes the polymer layer 5 begin to melt and, as it re-solidifies, it bonds with the backing layer 3. The transporting direction of the materials is indicated by an arrow. Laminating techniques that can be used are sufficiently well known to a person skilled in the art.

FIG. 2 schematically shows the production of an airbag from two wall parts 1, 2. Only a detail in a joining region V is respectively shown. The laminated materials produced according to FIG. 1 are suitably made up and used as wall parts 1, 2. In FIG. 2a, the wall parts 1, 2 are shown unjoined, but already spatially prearranged, to be precise in such a way that the second polymer layers 6 are facing one another. In FIG. 2b, the wall parts 1, 2 are represented in the joined state, the second polymer layers 6 being joined to one another in a joining region V under the effect of a second introduction of energy E₂. It can be ensured by suitable choice of the introductions of energy E₁ and E₂ that the joining of the second polymer layers 6 does not affect the lamination of the backing layer 3 and the first polymer layer 5 (known as orthogonal sensitivity).

FIG. 3 shows the embodiment according to FIG. 2b, but with a seam 9 in the joining region V, which may possibly provide additional stability. Such a seam 9 (or a number of seams) may be provided as an additional measure, but must be in a suitably dimensioned joining region V, so that the integrity of the seal of the fused polymer layers 6 is not impaired.

FIG. 4 shows a further embodiment of the invention, in which the overlapping of the wall parts 1, 2 in the joining region V is brought about differently. Here, the wall part is drawn around an edge region of the wall part 1, so that—in addition to the joining of the second polymer layers 6 as also shown in FIG. 2b—it comes to lie with its second polymer layer on the upper side of the wall part and an additional lamination can be performed there (compare FIG. 4b). This embodiment is distinguished by particularly great stability.

In FIG. 5, an embodiment in which the joining of the wall parts 1, 2 is brought about by means of an intermediate portion 7 is shown. In FIG. 5a, this is also shown separately: the intermediate portion has on its sides facing towards the second polymer layers 6 of the wall parts 1, 2 a material 8 that is identical to or chemically compatible with a material of the second polymer layers 6; in particular, it is intended for a fusing of the material 8 with the second polymer layers 6 to be made possible by an introduction of energy E₂, with which the polymer layers 6 could also be joined to one another. The intermediate portion 7 has an inner layer 9, for example of a material such as that which can also be used as the backing layer 3 for the wall parts 1, 2 (see above). FIG. 5b shows by way of example a joining of the wall parts 1, 2 brought about in such a way.

In FIG. 6 there is a further embodiment with a further variant of an intermediate piece. The intermediate piece 7 shown in FIG. 6 is folded in, into an intermediate region between the wall parts 1, 2, so that the material 8 faces towards the second polymer layers 6 of the wall parts 1, 2. The intermediate portion 7 has a lower layer 9, which, in the same way as the inner layer 9 in Figure in 5a, may consist of a material such as that which can also be used as the backing layer for the wall parts 1, 2 (see above). The configuration of the intermediate piece according to FIG. 6 makes it possible to dispense with a separate coating of two opposite sides of the intermediate piece 7 on account of the folding of the intermediate piece 7.

1-15. (canceled)

16. Airbag with at least one wall part, which wall part(s) comprise(s) or consist(s) of a laminated material, the laminated material comprising:
a backing layer,
an at least two-layered polymer film, with a first polymer layer, facing towards the backing layer, having a glass transition temperature T_{g1} of ≦10° C., and a second polymer layer, facing away from the backing layer, having a storage modulus according to the torsion pendulum test as specified by DIN 53 445 (August 1986) of ≧1 MPa at ≧90° C.,
the wall part(s) being joined together in at least one joining region, in such a way that the second polymer layers of the wall part(s) are either joined to one another directly or joined to one another indirectly by way of an intermediate portion.

17. Airbag according to claim 16, wherein the backing layer is a textile sheet-like structure and the wall parts(s) of the airbag are arranged in such a way that the textile sheet-like structure of the laminated material is on the outside in the operating state of the airbag.

18. Airbag according to claim 16, wherein the glass transition temperature T_{g1} is ≦−30° C.

19. Airbag according to claim 16, wherein the at least two-layered polymer film is laminated onto the backing layer.

20. Airbag according to claim 16, wherein the joining of the second polymer layers of various wall parts is brought about by introduction of a second energy E₂.

21. Airbag according to claim 16, wherein
the at least two-layered polymer film is laminated onto the backing layer by introduction of a first energy E₁;
the joining of the second polymer layers of various wall parts is brought about by introduction of a second energy E₂;
the backing layers and polymer layers are of such a nature that the first polymer layer(s), but not essentially the second polymer layer(s), can be melted by the introduction of energy E₁, and in that the second polymer layer(s), but not essentially the first polymer layer(s), can be melted by the introduction of energy E₂.

22. Airbag according to claim 16, wherein the first polymer layer, facing towards the backing layer, has a softening temperature Tₑ₁ and the second polymer layer, facing away from the backing layer, has a softening temperature Tₑ₂>Tₑ₁, according to DIN 53 445 with a storage modulus of >1 MPa.

23. Airbag according to claim 16, the second polymer layers of the wall part(s) being joined to one another indirectly by way of an intermediate portion, which intermediate portion comprises on its sides facing towards the second polymer layers at least partially a material which is identical to or chemically compatible with the material of the second polymer layer(s).

24. Airbag according to claim 16, wherein the wall part(s) is/are additionally joined in joining regions by mechanical means.

25. Method for producing an airbag, comprising the steps of:
a1) producing a laminated material comprising:
a backing layer,
an at least two-layered polymer film (4), with a first polymer layer, facing towards the backing layer, having a glass transition temperature T_{g1} of ≦10° C., and a second polymer layer, facing away from the backing layer, having a storage modulus according to the torsion pendulum test as specified by DIN 53 445 of ≧1 MPa at ≧90° C.;
by directly coating the backing layer; or by subsequently bringing the backing layer and the polymer film into contact and introducing energy E₁;
a2) or providing such a laminated material;
b) joining together the laminated material, if appropriate after it has been made up into suitably dimensioned wall parts, in joining regions, by introducing energy E₂ in such a way that the second polymer layers of the laminated materials are either joined to one another directly or joined to one another indirectly by way of an intermediate portion.

26. Method according to claim 25, wherein an at least two-layered polymer film or a laminated material with such a polymer film is provided, in the case of which the first polymer layer(s), but not essentially the second polymer layer(s), can be melted by the introduction of energy E₁, and in that the second polymer layer(s), but not essentially the first polymer layer(s), can be melted by the introduction of energy E₂.

27. Method according to claim 25, wherein an additional mechanical joining means, is at least partially provided in the joining region.

28. At least two-layered polymer film, a first polymer layer having a glass transition temperature T_{g1} of ≦10° C., and a second polymer layer, facing away from the backing layer, having a storage modulus according to the torsion pendulum test as specified by DIN 53 445 of ≧1 MPa at ≧90° C.

29. Polymer film according to claim 28, wherein the first polymer layer, but not essentially the second polymer layer, can be melted by the introduction of energy E₁, and wherein the second polymer layer, but not essentially the first polymer layer, can be melted by a second introduction of energy E₂.

30. Laminated material for producing an airbag, comprising a polymer film according to claim 28, which polymer film is laminated with one of its polymer layers onto a backing layer.

31. Passive restraint system, in particular for a motor vehicle, comprising at least one airbag according to claim 16.
